(19) United States
(12) Patent Application Publication
(10) Pub. No.: US 2005/0131984 A1
(43) Pub. Date: Jun. 16, 2005

(54) Method for transmitting data from applications with different quality

(75) Inventors: Jens Hofmann, Schildow (DE); Jens Schneider, Berlin (DE)

Correspondence Address: MORRISON & FOERSTER LLP, 1650 TYSONS BOULEVARD, SUITE 300, MCLEAN, VA, 22102, US

(73) Assignee: Siemens Aktiengesllschaft, Munchen (DE)

(21) Appl. No.: 10/497,964

(22) PCT Filed: Dec. 10, 2001
(86) PCT No.: PCT/DE01/04724

(51) Int. Cl. G06F 15/16

(52) U.S. Cl. 709/201

(57) ABSTRACT

The invention relates to a method for transmitting data of applications with different quality requirements in a packet-oriented data communication network that comprises communication nodes. The inventive method comprises the following steps: a) limiting the data of every application to a defined bit rate in a communication node to be passed during transmission of the data of the respective application; b) generating and storing application-specific contexts in all communication nodes to be passed during transmission of the data of the respective application; c) reserving, in line with the application-specific contexts, transmission resources in all communication nodes to be passed during transmission of the data of the respective application; d) forwarding, in line with the application-specific contexts, the data of every application from a communication node to be passed by the respective application to another communication node to be passed.

### CLAIM FOR PRIORITY

This application claims priority to International Application No. PCT/DE01/04724 which was published in the German language on Jul. 3, 2003, and filed in the German language on Dec. 10, 2001.

### TECHNICAL FIELD OF THE INVENTION

The present invention relates to a method for transmitting data from applications with different requirements in terms of the quality of a transmission service in a packet switched data communication network.

### BACKGROUND OF THE INVENTION

A fundamental feature of packet switched data communication networks is that data transmission takes place not via dedicatedly connected data paths, but rather via virtual data paths according to the principle of random multiplexing. In this context, multiplexing is understood to mean the simultaneous transmission of a plurality of information items via the same transmission path on the basis of the random distribution of the various information items over time. The data which are usually transmitted in such networks are distinguished by a “burst” characteristic, i.e. by fluctuations in their bandwidth over time. In order to be able to transmit the data effectively, they are generally aggregated between communication nodes in the packet switched data communication network, and statistical assumptions are used to transmit them together from communication node to communication node via existing transport paths, i.e. via virtual data paths. There is no exclusive provision of transmission resources for individual applications on an “end to end” basis. The random multiplexing makes effective use of the existing transmission resources. In contrast, in circuit switched data communication networks, each application is provided with a dedicated path through the data communication network, on which both the transmission time and the bandwidth are guaranteed. If data are transmitted at a variable bit rate in this case, the available bandwidth is not exhausted in the case of pauses or periods in which the transmission rate is low.

Any application in a mobile packet switched data communication network demands particular resources for the transfer capacity from the data communication network for the duration of the application, in order to allow “end to end” communication. In mobile packet switched data communication networks, this is done by applying a “context” with an appropriate set of parameters at every affected communication node which needs to be encountered. A context contains all of the relevant information which provides an adequate description of the service required for transmitting the data. In particular, each application requires a particular transmission service in a particular quality (QoS—Quality of Service) from the data communication network. This requirement is characterized by “QoS parameters”, such as a maximum bit rate, a guaranteeable bit rate and a maximum permissible delay. When a context is created, each communication node negotiates these QoS parameters in line with its existing resources, with the parameters each being negotiated in stages. The respective application's data are then transmitted on the basis of these negotiated and stored QoS parameters, which are the same at all of the communication nodes which are to be encountered.

To date, the problem of transmitting data from applications with different requirements in terms of the quality of transmission has been solved in different ways.

There is a QoS architecture from the 3GPP (TS 23.107) which describes particular QoS functions for 3rd generation (UMTS) mobile radio networks. Implementation at individual communication nodes is not specified in more detail, however. In addition, there are approaches which describe methods for transmitting data from applications with different QoS requirements in a data communication network.

A first approach involves providing each data packet with information about the demanded transmission quality. In this case, particular quality classes, which provide a suitable reflection of the transmission requirements, are defined in a data communication network. These classes are then called Quality of Service classes. Each data packet is assigned to a QoS class and is provided with corresponding information. Each communication node (which forwards data in such a data communication network) which is to be encountered prioritizes the forwarding of a data packet on the basis of the QoS information which each data packet contains. In this case, the usual treatment is to distribute packets in appropriate queues according to the QoS information these packets contain. These queues are emptied and forwarded at different speeds according to their QoS class. This approach statistically increases the probability of a high priority data packet being routed through the data communication network much more quickly than a data packet with low priority. A drawback of this approach is that there is no guaranteed transmission time and transmission rate within the data communication network. Other drawbacks are that data packets requiring transmission in real time are buffer stored in every queue and are thus delayed. Another drawback is that the information about the association with a QoS class needs to be contained in every data packet and that the format of this information needs to be the same throughout the data communication network. This approach is described, by way of example, in the RFC 2474 standard from IETF (Internet Engineering Task Force).

A second approach to solving the problem described above involves setting up different data paths within the data communication network for each QoS class. If a communication node is able to associate a data packet with a QoS class, this data packet is forwarded on a data path which corresponds to this QoS class.

A drawback of this method is the costs for setting up and operating a large number of different paths of different quality between different communication nodes. The setup of different paths in different QoS classes has been defined in various standards, for example in the Traffic Management Specification, also called AF-TM-0121.000 by the ATM forum.

A third approach involves limiting the total traffic at the access node into the data communication network, an “edge node”, to a predefined traffic level. This traffic level will then not differ again within the data communication network, since it is presupposed that the data communication network has adequate dimensions. The drawback of this approach is the lack of any guarantee with regard to transmission time and transmission rate. This approach is specified by the IETF's Service Level Agreement Working Group, for example.

### SUMMARY OF THE INVENTION

The present invention relates to a method for transmitting data from applications with different requirements in terms of the quality of a transmission service in a packet switched data communication network. In packet switched data communication networks with, by way of example, IP based transmission mechanisms, different data types from various applications are transmitted from a source to a destination via a network. In this context, the requirements in terms of the manner of transmission between various applications vary greatly. This applies particularly to the transmission of data from applications which require transmission in real time and/or using a guaranteed bit rate, as compared with transmission of data which are not subject to stringent requirements in terms of transmission in real time and/or in terms of a guaranteed bit rate. Applications requiring transmissions in real time and with a guaranteed bit rate are, by way of example, voice telephony, online radio and video transmission. By contrast, electronic mail services or Internet applications, such as web surfing, have no comparable requirements in terms of transmission.

The present invention provides a method which can be used to transmit data from applications with different transmission requirements within the data communication network as efficiently as possible and avoiding the above drawbacks.

In one embodiment of the invention, there is a method for transmitting data from applications with different transmission requirements in a packet switched data communication network containing communication nodes, including:
a. each application's data are limited to a prescribed bit rate at a communication node which is to be encountered when a respective application's data are transmitted,
b. application specific contexts are created and stored at the communication nodes which are to be encountered when a respective application's data are transmitted,
c. transmission resources are reserved at the communication nodes which are to be encountered when a respective application's data are transmitted, in line with the application specific contexts,
d. each application's data are forwarded from a communication node which is to be encountered by the respective application to a further communication node which is to be encountered, in line with the application specific contexts.

In one preferred embodiment of the invention, (a) is performed at an access communication node (edge node) to the packet switched data communication network. An incoming stream of data from an application is limited to a prescribed, preferably to a maximum permissible bit rate which is determined by the resources existing in the data communication network. This ensures that there is no longer any possibility of impermissible excess at the subsequent communication nodes which are to be encountered in the data communication network.

Preferably, each application's data are limited to a prescribed bit rate by measuring the volume of a respective application's data over a settable time interval in parallel with the forwarding of these data and comparing it with the volume of data which corresponds to the prescribed bit rate. This means that, over a particular interval of time (measurement interval), the size of incoming data packets is summed in parallel with their forwarding. This value reflects the volume of data within this time interval. If, by way of example, the maximum permissible volume of data corresponding to the maximum bit rate is now reached in this time interval, then this information may be used to decide whether subsequent data packets are rejected or are possibly transported further, since the communication node's total resources permit this. At the start of the subsequent measurement interval, the size of the data packets starts to be summed again, this summation also being able to start from a start value which is not equal to zero, for example in order to take into account previous bursts. Hence, firstly any delay in the data packets is minimized and secondly the negotiated data rate is prevented from being exceeded at the subsequent communication nodes. At the same time, all other communication nodes in the data communication network which are to be encountered on this data path no longer need to monitor the maximum permissible bit rate.

In one preferred embodiment of the invention, each communication node which is to be encountered by a respective application's data uses a guaranteed bit rate, required by the respective application, and a maximum supportable bit rate to derive a bandwidth value for a transmission resource which is to be reserved, and reserves this transmission resource.

In another preferred embodiment of the invention, the method is performed for data from applications which require transmission in real time. This means that, when setting up a context for an application requiring real-time transmission (real-time application), each communication node which is to be encountered takes a requested guaranteed bit rate and the maximum supportable bit rate and derives a particular bandwidth value for a resource (B_{RealAppl}) which is to be reserved and reserves this bandwidth for this application. The calculation of the bit rate which is to be reserved can also take into account measurements relating to the actual resource requirement of applications which are active and which have been active. In general, a particular share of the resources (B_{SumReal}) in the total transmission width Bₜₒₜₐₗ is reserved for the total real-time traffic at the communication node. This means that the bandwidth value (B_{RealAppl}) ascertained for the application is taken from the share B_{SumReal} which is reserved for the real-time traffic. This means that the application has the bandwidth B_{RealAppl} at the communication node available. When the application has ended, these reserved resources are released again. The share B_{SumReal} reserved for real-time traffic is preferably chosen to be smaller than the total bandwidth at the communication node. This ensure that firstly a particular share of the resources is available for applications which do not require real-time transmission (nonrealtime application), and secondly brief excesses over the reserved bandwidth (bursts) can likewise be transmitted for realtime applications. For applications which do not require real-time transmission and without a guaranteed bit rate, no bandwidth is reserved for a single application. Instead, the unreserved share B_{SumNonReal} of the total resources is reserved for such applications (B_{SumNonReal}=Bₜₒₜₐₗ−B_{SumReal}). At the same time, applications which do not require real-time transmission are also able to use the resources which are reserved for real-time applications but are temporarily not being used for these. Random multiplexing can be used to transport data from this application with a particular probability. If the actual volume of data in the non-real-time traffic exceeds the bandwidth which is available for the traffic, this traffic is delayed or rejected. The actual sum of data to be transported for the real-time applications may exceed the resources reserved therefor. This is the case, for example, when data streams having the maximum bit rate arrive at the communication node at the same time for all or a large number of real-time applications, and a smaller bandwidth has been reserved for these services. When this case arises, portions of the resources provided for non-real-time applications are used concurrently for transporting the real-time applications' data. A correspondingly smaller amount of resources is then available for the data transmission for non-real-time applications. The share of reserved resources B_{SumReal} and the calculation algorithm for the bandwidth which is to be reserved govern the extent to which the real-time applications' data may exceed the reserved resources and how high the probability is that data from non-real-time applications will be transported. In this case, the number of randomly multiplexed data streams for the applications, inter alia, may also be of significance. The larger the reserved share for real-time applications, the lower the probability that temporary excesses (bursts) over the reserved bandwidth will be able to be transmitted. The larger the share of the reserved share for real-time applications, the lower the probability that data from non-real-time applications will be transported.

In one preferred embodiment of the invention, this behavior can be influenced when activating a context, i.e. when negotiating the QoS parameters. When the application specific contexts are created at each communication node, the ratio of a guaranteed bit rate required by the respective application and a maximum supportable bit rate can preferably be varied and hence restricted.

In line with the invention, under particular assumptions, it is also possible to transmit data for real-time applications up to the maximum guaranteed bit rate B_{maxRealAppl} at each communication node without jams forming or data packets being rejected when these data and the guaranteed bit rate are transmitted. Firstly, bursts, i.e. brief transmission at high bit rates, should occur in randomly distributed form. There will then be a high probability that the sum of the reserved bandwidth B_{SumReal} will not be exceeded. In the event of excesses, a portion of the resources which has been reserved for non-real-time applications will be used concurrently. In this case, the sum of the maximum bit rate for all contexts the total resources at a communication node must not exceed a measure determined on the basis of ordinary proportioning methods.

In another preferred embodiment of the invention, the method involves the applications' data being classified into at least two categories in line with the application specific contexts and being forwarded in line with these categories. These two categories advantageously represent at least the classification into real-time applications and non-real-time applications. This categorization is preferably performed at each communication node and, as already mentioned, takes place on the basis of the contexts which exist at the communication node. Each data packet which has been assigned to a real-time application is forwarded to the next communication node immediately without buffer storage. Packets without any real-time requirement can be buffer stored in queues and can be forwarded from the queue in line with a particular reading mechanism. This reading mechanism is able, by way of example, to distribute the available transfer resources for the total non-real-time traffic or for portions thereof according to a predefined scheme or is able to implement simple prioritization for the queues. In this case, the available transfer resources for the non-real-time data are dependent on the instantaneous data volume in the real-time data.

One particular advantage of the present invention is that by combining the mechanisms described, such as reservation of transfer resources, limiting of data streams for individual applications to the maximum data rate, and prioritization of various categories of aggregated data streams when handling and transporting these data streams, it is possible to ensure transmission which is as effective as possible and is aligned with the individual requirements of a wide variety of applications.

### BRIEF DESCRIPTION OF THE DRAWINGS

Further advantages of the invention are presented with the aid of the figures below, in which:

FIG. 1 shows a block diagram for illustrating an embodiment of the invention.

FIG. 2 shows a block diagram for illustrating another embodiment of the invention.

### DETAILED DESCRIPTION OF THE INVENTION

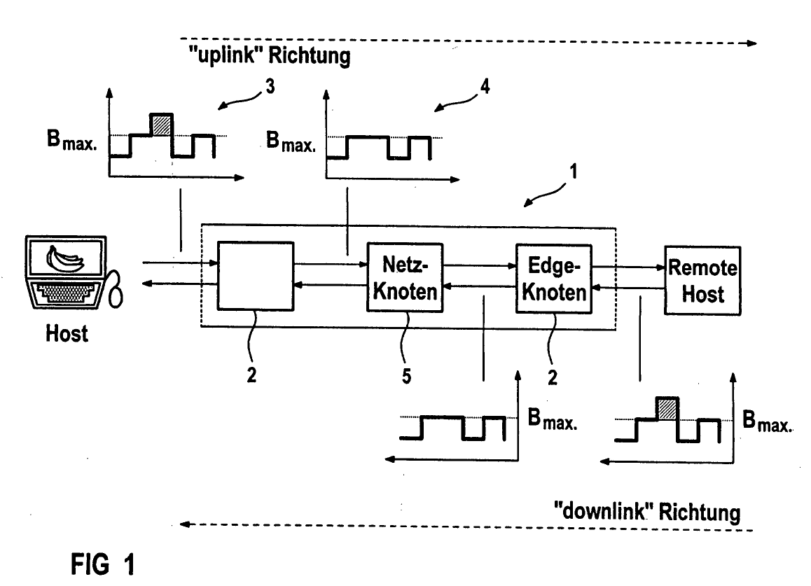

FIG. 1 shows a block diagram to describe a possible way of limiting data for an application to a prescribed bit rate. An application's data reach the data communication network 1 via an access node (edge node) 2. To achieve the shortest possible delay at the edge node 2 and to dispense with buffer storage for the purpose of ascertaining the bit rate of the incoming data, this behavior can be produced in the following manner: over a particular interval of time (measurement interval), the size of incoming data packets is summed in parallel with their forwarding, as indicated by the “uplink” direction arrow, this situation being shown in graph 3. This value reflects the volume of data in this time interval. If the maximum permissible volume of data corresponding to the maximum bit rate Bₘₐₓ is reached within this interval, then this information can be used to decide whether subsequent data are rejected, as shown in graph 4, or are possibly transported further, since the total resources at the edge node 2 allow this. The same mechanism is effected in the opposite direction, i.e. in the “downlink” direction. At the start of a subsequent time interval or measurement interval, the size of the data packet is summed again, with this summation also being able to start from a start value which is not equal to zero, for example in order to take bursts into account. This firstly minimizes the delay for the data packets and secondly prevents the negotiated data rate from being exceeded at subsequent communication nodes 5. At the same time, all other communication nodes 5 which are to be encountered no longer need to monitor the maximum bit rate Bₘₐₓ.

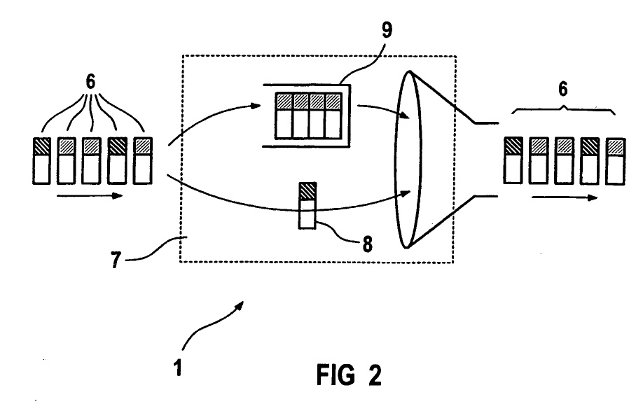

FIG. 2 shows a block diagram for schematically illustrating step d. in an embodiment of the inventive method. It shows data packets 6 from various applications being forwarded through a data communication network 1 which comprises a plurality of communication nodes 7. When an application is requested, the communication nodes 7 in the data communication network 1 which are to be encountered by the requested application's data or data packets 6 create a context which contains, inter alia, the transmission quality (QoS) which is to be requested for the application. This requirement is determined by various parameters. These include, inter alia, a maximum bit rate, a guaranteed bit rate and a maximum permissible delay. A data packet 6 arriving in the data communication network 1 from an application is now assigned to one of two categories 8, 9 at the communication nodes 7 which are to be encountered, in line with the context created and stored at the respective communication nodes 7. In the example shown, the two categories 8, 9 correspond to a classification into real-time applications (black stripe) 8 and non-real-time applications (gray stripe) 9. This categorization is performed at each communication node 7 which is to be encountered. Each data packet 6 which has been assigned to a real-time application is forwarded to the next communication node 7 immediately without buffer storage. Data packets 6 without any real-time requirement can be buffer stored in queues and forwarded from the queue in line with a particular reading mechanism. This reading mechanism can distribute the available resources for the total data packets 6 from non-real-time applications or for portions thereof according to a predefined scheme or can implement simple prioritization for the queues. In this case, the available resources for the data packets 6 from non-real-time applications are dependent on the instantaneous data volume for the real-time applications.

1. A method for transmitting data from applications having different transmission requirements in a packet switched data communication network including communication nodes comprising:
limiting each application's data to a prescribed bit rate at a communication node which is to be encountered when a respective application's data are transmitted;
creating and storing application specific contexts at the communication nodes which are to be encountered when a respective application's data are transmitted;
reserving transmission resources at the communication nodes which are to be encountered when a respective application's data are transmitted, in line with the application specific contexts; and
forwarding each application's data the communication node which is to be encountered by a respective application to a further communication node which is to be encountered, in line with the application specific contexts.

2. The method as claimed in claim 1, wherein limiting is performed at an access communication node into the packet switched data communication network.

3. The method as claimed in claim 1, wherein each application's data are limited to a prescribed bit rate by measuring a volume of the respective application's data over a settable time interval in parallel with forwarding of the data and comparing it with the volume of data which corresponds to the prescribed bit rate.

4. The method as claimed in claim 1, wherein reserving is performed for data from applications which require transmission in real time.

5. The method as claimed in claim 1, wherein reserving involves each communication node which is to be encountered by a respective application's data using a guaranteed bit rate, required by the respective application, and a maximum supportable bit rate to derive a bandwidth value for a transmission resource which is to be reserved, and reserving the transmission resource.

6. The method as claimed in claim 1, wherein when the application specific contexts are created at each communication node, the ratio of a guaranteed bit rate required by the respective application and a maximum supportable bit rate can be varied.

7. The method as claimed in claim 1, wherein a particular share of transmission resources from total transmission resources is reserved for data from applications which respectively require transmission in real time.

8. The method as claimed in claim 7, wherein the share of transmission resources which is reserved for data from applications which respectively require transmission in real time is chosen to be smaller than a total quantity of transmission resources.

9. The method as claimed in claim 1, wherein forwarding includes the applications' data being classified into at least two categories in line with the application specific contexts and being forwarded in line with these categories.

10. The method as claimed in claim 9,
wherein the two categories correspond to classification into real-time applications and non-real-time applications.
